(19) United States
(12) Patent Application Publication
(10) Pub. No.: US 2025/0276400 A1
(43) Pub. Date: Sep. 4, 2025

(54) SYSTEMS AND METHODS FOR HIGH-SPEED PLASMA ARC PROCESSING

(71) Applicant: Hypertherm, Inc., Hanover, NH (US)

(72) Inventors: John Gagne, Canaan, NH (US); Jon W. Lindsay, Grantham, NH (US); Soumya Mitra, Lebanon, NH (US); Matt Davis, Lebanon, NH (US); Scott Eshleman, Lebanon, NH (US); Zheng Duan, Hanover, NH (US)

(21) Appl. No.: 19/069,640

(22) Filed: Mar. 4, 2025

Related U.S. Application Data
(60) Provisional application No. 63/560,947, filed on Mar. 4, 2024.

(51) Int. Cl. B23K 10/00; B23K 9/10; H05H 1/34; H05H 1/36

(52) U.S. Cl. CPC B23K 10/006; B23K 9/1062; H05H 1/3405; H05H 1/3423; H05H 1/3489; H05H 1/36

(57) ABSTRACT

A material processing system is provided that includes a contact-start plasma arc torch connected to a power supply via a torch lead and a computing device in electrical communication with the plasma arc torch. The computing device includes an arc initiation module and a transition module. The arc initiation module configured to (i) cause the contact-start plasma arc torch to emit a first thermal arc to cut a first part from a workpiece and (ii) terminate the first thermal arc at the second location after the first part is cut from the workpiece. The transition module is configured to, upon detection of the termination of the first thermal arc at the second location, automatically (i) initiate a reset of the plasma arc torch and (ii) delay initiation of a post-flow process in the torch.

### CROSS REFERENCE TO RELATED APPLICATION

This application claims the benefit of and priority to U.S. Provisional Patent Application No. 63/560,947 filed on Mar. 4, 2024, the entire content of which is owned by the assignees of the instant application and incorporated herein by reference in its entirety.

### TECHNICAL FIELD

The present invention generally relates to systems and methods for optimizing cutting speed of a plasma arc processing system when transitioning from cutting between two parts on a workpiece.

### BACKGROUND

Plasma arc torches are widely used for high temperature processing (e.g., cutting, welding, and marking) of metallic materials. A plasma arc torch generally includes a torch body, an electrode mounted within the body, an emissive insert disposed within a bore of the electrode, a nozzle with a central exit orifice, a shield, electrical connections, passages for cooling and arc control fluids, a swirl ring to control the fluid flow patterns, and a power supply. The plasma arc torch can produce a plasma arc, which is a constricted, ionized jet of plasma gas with high temperature and high momentum. Gases used in the torch can be non-reactive (e.g., argon or nitrogen) or reactive (e.g., oxygen or air).

Conventional plasma arc cutting using a plasma arc torch is traditionally slow to cut, especially for thin metals, as compared to other industrial cutting solutions, such as laser cutting. This is partly due to requisite pre- and post-cut flow requirements for cutting with a plasma arc torch, which are designed to extend consumable life of the torch and improve cut outcomes, but result in legacy plasma cut charts functioning at relatively low speeds and requiring significant amounts of time between performing distinct cuts on a workpiece. For example, most traditional plasma systems enter post-flow processing immediately after a cut to initiate cooling of the consumables, and a torch reset is only conducted when the torch is positioned over the next part and the plasma-on command is received. Such an operational method and sequencing (e.g., post-flow, reset, etc.) does not drastically impact system productivity because today's plasma cutting systems still use legacy cut charts to perform cutting (e.g., at the speeds of 30 and 40 years ago). However, these legacy cut charts and operational sequencing methods significantly limit the efficiency of modern plasma cutting systems, which in turn limits plasma torch output capability.

Therefore, there is a need for plasma cutting systems and methods, including sequences of operation, designed to improve plasma cutting performance, output capability, and efficiency (e.g., reduce cut-to-cut time, increase cut speeds, etc.).

### SUMMARY

The present invention features, in some embodiments, a process flow in which cut-to-cut time between parts on a workpiece is reduced, such as by immediately resetting the plasma arc torch after each cut instead of waiting until the next “plasma on” command at the next part. The process flow can be implemented in a nesting software embedded in a hardware device (e.g., a firmware) for providing a suitable cutting program that sets desired parameters for processing the workpiece to produce the desired cuts.

In one aspect, the present invention features a material processing system including a contact-start plasma arc torch connected to a power supply via a torch lead and computing device in electrical communication with the plasma arc torch. The computing device comprises an arc initiation module configured to (i) cause the contact-start plasma arc torch to emit a first thermal arc to cut a first part from a workpiece by cutting from a first location to a second location on the workpiece in association with the first part, and (ii) terminate the first thermal arc at the second location after the first part is cut from the workpiece. The computing device also comprises a transition module configured to, upon detection of the termination of the first thermal arc at the second location, automatically (i) initiate a reset of the plasma arc torch when the plasma arc torch is translated from the second location to a third location on the workpiece in association with cutting a second part from the workpiece, and (ii) delay initiation of a post-flow process in the torch in association with a time period. Initiate the reset of the plasma arc torch comprises cause bleed down of the torch lead during the torch translation to depressurize gas build-up in the torch lead. The arc initiation module is further configured to cause the plasma arc torch to emit a second thermal arc to cut at the third location associated with the second part within about 1 second of the plasma arc torch arrival at the third location.

In another aspect, the present invention features a computerized method for transitioning a contact-start plasma arc torch from cutting a first part from a workpiece to cutting a second part from the workpiece. The plasma arc torch is connected to a power supply via a torch lead. The method includes causing the plasma arc torch to emit a first thermal arc to cut the first part from the workpiece by cutting from a first location to a second location on the workpiece in association with the first part and causing the plasma arc torch to terminate the first thermal arc after the first part is cut from the workpiece at the second location. The method also includes upon termination of the first thermal arc at the second location, automatically (i) initiating a reset of the plasma arc torch while translating the plasma arc torch from the second location to a third location on the workpiece in association with starting the cut of the second part from the workpiece, and (ii) delaying initiation of a post-flow process in the torch in association with a time period. Initiating the reset of the plasma arc torch comprises causing bleed down of the torch lead during the translating from the second location to the third location to depressurize gas build-up in the torch lead. The method further includes causing the plasma arc torch to emit a second thermal arc to cut at the third location associated with the second part within about 1 second of the plasma arc torch arriving at the third location.

Any of the above aspects can include one or more of the following features. In some embodiments, In some embodiments, the post-flow process in the torch comprises flowing a cooling gas through one or more consumables of the plasma arc torch to cool the plasma arc torch. In some embodiments, the computing device, including the arc initiation module and the transition module, is disposed on the power supply. In some embodiments, at least a portion of the transition module or the arc initiation module is embedded in a firmware of the power supply. In some embodiments, the arc initiation module causes the plasma arc torch to emit the first thermal arc by actuating a valve in the power supply to allow a sufficient supply of a gas to flow to the plasma arc torch, thereby generating a blowback pressure within the plasma arc torch to physically separate an electrode from contacting a nozzle in the plasma arc torch.

In some embodiments, the transition module is configured to initiate the reset of the plasma arc torch within about 1 second of the termination of the first thermal arc. In some embodiments, the transition module is configured to initiate the reset of the plasma arc torch prior to the arc initiation module causing the plasma arc torch to emit the second thermal arc. In some embodiments, initiate the reset of the plasma arc torch by the transition module further comprises initiate a reset of an electrode within the plasma arc torch by urging the electrode into physical contact with a nozzle within the plasma arc torch. In some embodiments, the transition module is further configured to automatically initiate another reset of the plasma arc torch prior to causing the plasma arc torch to emit the second thermal arc.

In some embodiments, the time period associated with delaying the post-flow process in the torch is determined based on at least one of a length of the torch lead, a type of at least one consumable or cartridge of the plasma arc torch, or an operator set value. In some embodiments, the time period associated with delaying the post-flow process in the torch is between about 2 seconds and about 20 seconds from the termination of the first thermal arc.

In some embodiments, delaying the initiation of the post-flow process comprises the transition module initiating the post-flow process after the time period, if the plasma arc torch does not arrive at the third location of the second part within the time period. In some embodiments, delaying the initiation of the post-flow process comprises the transition module canceling the post-flow process in the plasma arc torch between the second location and the third location, if the plasma arc torch arrives at the third location within the time period. In some embodiments, the transition module is further configured to interrupt the post-flow process of the plasma arc torch if the plasma arc torch arrives at the third location while the post-flow process is in progress to enable the arc initiation module to initiate the second thermal arc to cut at the third location.

In some embodiments, the computing device further comprises a decision component configured to determine a type of the plasma arc torch. In some embodiments, the transition module is configured to initiate the reset of the plasma arc torch and the delay of the post-flow process after the termination of the first thermal arc if the type of the plasma arc torch is a mechanized plasma arc torch. In some embodiments, the transition module is configured to initiate the post-flow process without delay after the termination of the first thermal arc if the type of the plasma arc torch is a handheld plasma arc torch.

In some embodiments, the plasma arc torch cuts from the first location to the second location of the first part on the workpiece at a speed-thickness value of greater than about 35 inches²/min. The speed-thickness value is defined as a speed of the plasma arc torch multiplied by a thickness of the workpiece. In some embodiments, the plasma arc torch cuts the first part from the first location to the second location on the workpiece at a speed-to-amp ratio of greater than about 5 inches/min*A. The speed-to-amp ratio is defined as a speed of the plasma arc torch divided by an amount of electrical current supplied to the plasma arc torch.

In some embodiments, the system includes a motion control module configured to translate the plasma arc torch from the second location to the third location on the workpiece to enable cutting of the second part from the workpiece at the third location. In some embodiments, the motion control module is further configured to translate the plasma arc torch to a fourth location between the second and third location to enable purging of the plasma arc torch at the fourth location.

In yet another aspect, the present invention features a computerized method for selecting a part nest for processing a workpiece by a plasma arc torch. The computerized method includes receiving, by a computing device, information related to a plurality of parts to be cut from the workpiece by the plasma arc torch and generating, by the computing device, a layout of the plurality of parts to be cut based on the information. The method also includes predicting, by the computing device, a set of transition sequences to be completed by the plasma arc torch based on the layout of the plurality of parts. Each transition sequence is intended for implementation during translation of the plasma arc torch enroute from an initial part to a next part of the plurality of parts. The method further includes generating, by the computing device, a cutting plan comprising a sequence of the plurality of parts to be cut such that the set of transition sequences is substantially accomplished during translation of the plasma arc torch among the plurality of parts.

In some embodiments, each transition sequence in the set of transition sequences is implemented within the plasma arc torch during the translation from the initial part to the next part, without the plasma arc torch generating a thermal arc. In some embodiments, the sequence of the plurality of parts in the cutting plan is generated by further accounting for at one of a thickness of the workpiece, a desired cut quality, an available cut speed for operating the plasma arc torch, or an available current setting in amperage for operating the plasma arc torch. In some embodiments, the sequence of the parts to be cut in the cutting plan is generated to minimize a total duration of the plasma arc torch operating without a thermal arc and maximize a total duration of the plasm arc torch operating with a thermal arc.

In some embodiments, during each transition sequence, (i) a reset of the plasma arc torch is implemented upon termination of a thermal arc associated with cutting the initial part and (ii) a post-flow process in the torch is delayed. In some embodiments, the reset of the plasma arc torch comprises at least one of causing bleed down of a torch lead during the torch translation to depressurize gas build-up in the torch lead or resetting an electrode within the plasma arc torch by urging the electrode into physical contact with a nozzle within the plasma arc torch, and the post-flow process comprises flowing a cooling gas through one or more consumables of the plasma arc torch to cool the plasma arc torch. In some embodiments, the torch reset is initiated within about 1 second of the termination of the thermal arc associated with cutting the initial part.

In some embodiments, a time period associated with delaying the post-flow process in the torch is between about 2 seconds and about 20 seconds from the termination of the thermal arc. In some embodiments, delaying the post-flow process comprises initiating the post-flow process after the time period during the torch translation from the initial part to the next part, if the plasma arc torch does not arrive at the next part within the time period. In some embodiments, delaying the post-flow process comprises cancelling the post-flow process during the translation from the initial part to the next part, if the plasma arc torch arrives at the next part within the time period. In some embodiments, the post-flow process is interrupted if the plasma arc torch arrives at the next part while the post-flow process is in progress to enable initiation of another thermal arc to cut the next part.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 shows an exemplary plasma arc processing system, according to some embodiments of the present invention.

FIG. 2 shows an exemplary computerized process utilizing the plasma arc processing system of FIG. 1 for determining and implementing a sequence of torch actions to minimize cut-to-cut time between parts on the workpiece, according to some embodiments of the present invention.

FIG. 3 shows an exemplary sequence of torch actions for cutting between a first part and a second part on a workpiece utilizing the plasma arc processing system of FIG. 1 that employs the cut-to-cut transition process of FIG. 2, according to some embodiments of the invention.

FIG. 4 shows an exemplary sequence for cutting between a first part and a second part on a workpiece if the arc initiation module of the plasma arc processing system of FIG. 1 issues the “plasma on” command for cutting the second part during the post-flow delay period, according to some embodiments of the present invention.

FIGS. 5a and 5b show exemplary tables of Speed Thickness values with raw calculations and 1000 time increased for better visibility/normalization, respectively, according to some embodiments of the present invention.

FIGS. 6a and 6b show exemplary tables of Speed-to-Amp ratios with raw calculations and 1000 time increased for better visibility/normalization, respectively, according to some embodiments of the present invention.

FIG. 7 shows an exemplary process implemented by a nesting program of the plasma arc processing system of FIG. 1 to determine a cut sequence of parts relative to a workpiece, according to some embodiments of the present invention.

FIG. 8 shows an exemplary nest, i.e., a cut sequence of parts, automatically generated by a nesting program using the process of FIG. 7, according to some embodiments of the present invention.

### DETAILED DESCRIPTION

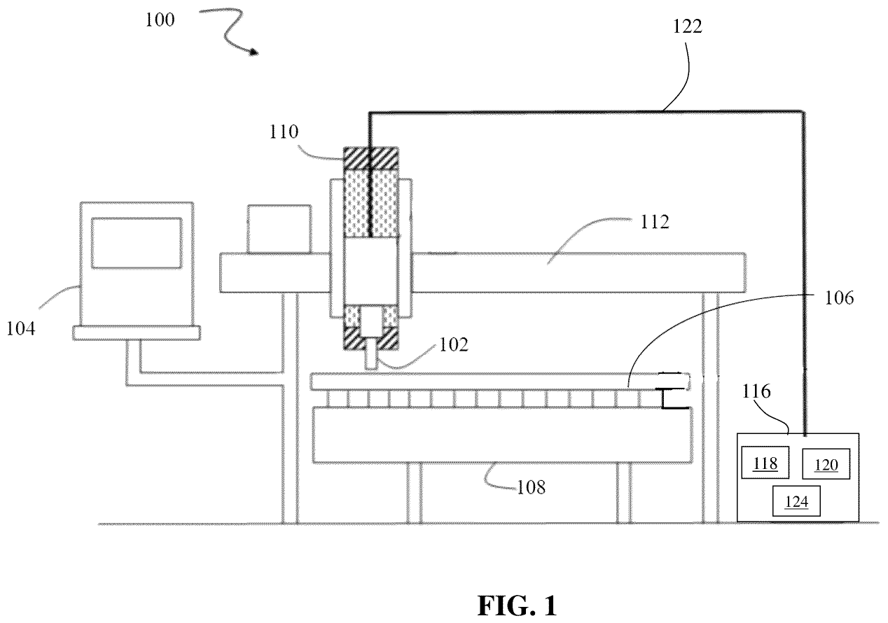

FIG. 1 shows an exemplary plasma arc processing system 100, according to some embodiments of the present invention. As shown, the system 100 generally includes a contact-start plasma arc torch 102 in electrical communication with a processor 104, which can be a digital signal processor (DSP), microprocessor, microcontroller, computer, computer numeric controller (CNC) machine tool, programmable logic controller (PLC), application-specific integrated circuit (ASIC), or the like. The plasma arc torch 102 is configured to generate a plasma arc for processing a workpiece 106. In an exemplary arrangement of the plasma arc processing system 100 as shown in FIG. 1, the workpiece 106 is placed on a cutting table 108, and the torch 102 is mounted into a torch height controller 110, which is attached to a gantry 112. The processor 104 is configured to interact with various system modules of the plasma arc processing system 100 to control the relative motion between the tip of the torch 102 and the workpiece 106 while directing the plasma arc of the torch 102 along a processing path on the workpiece 106 to cut the workpiece 106 at various parts. The system 100 also includes a power supply 116 configured to interact with various system modules to control the current, voltage and/or power supplied to the torch 102 for processing the workpiece 106. In some embodiments, the processor 104 and the power supply 116 are integrated into one component. Alternatively, they are separate components as illustrated in FIG. 1. The contact-start plasma arc torch 102 can be connected to the power supply 116 via a torch lead 122.

In general, the processor 104 and/or the power supply 116 are configured to control and optimize the operation of the plasma arc torch 102 relative to the workpiece 106 by regulating many plasma system functions that include, but are not limited to, start sequence, CNC interface functions, gas and operating parameters, pre-flow and post flow operations, and shut off sequences. For example, the processor 104 and/or the power supply 116 control various system modules including (i) an arc initiation module 118 for actuating the contact-start plasma arc torch 102 to emit thermal arcs (e.g., plasma arcs) to cut the workpiece 106 by issuing “plasma on” commands, (ii) a motion control module 120 for adjusting the lateral movement of the torch 102 in relation to the surface of the workpiece 106, and (iii) a transition module 124 for implementing a suitable sequence of actions within the torch 102 between cuts (e.g., as the torch 102 transitions from one part to the next part relative to the workpiece 106). In some embodiments, the arc initiation module 118 causes the plasma arc torch 102 to emit thermal arcs by actuating a valve (not shown) in the power supply 116 to allow a sufficient supply of a gas to flow to the plasma arc torch, 102, thereby generating a blowback pressure within the plasma arc torch 102 to physically separate an electrode (not shown) from contacting a nozzle (not shown) in the plasma arc torch 102. In some embodiments, the arc initiation module 118 and/or the transition module 124 is implemented by a nesting software (not shown) for providing a suitable cutting program that sets desired parameters for processing the workpiece 106 to achieve desired results, such as producing desired parts at an improved and/or optimized speed/time. Even though the modules 118, 120, 124 are shown in FIG. 1 as a part of the power supply 116, in alternative embodiments, one or more of these modules can be implemented on the processor 104.

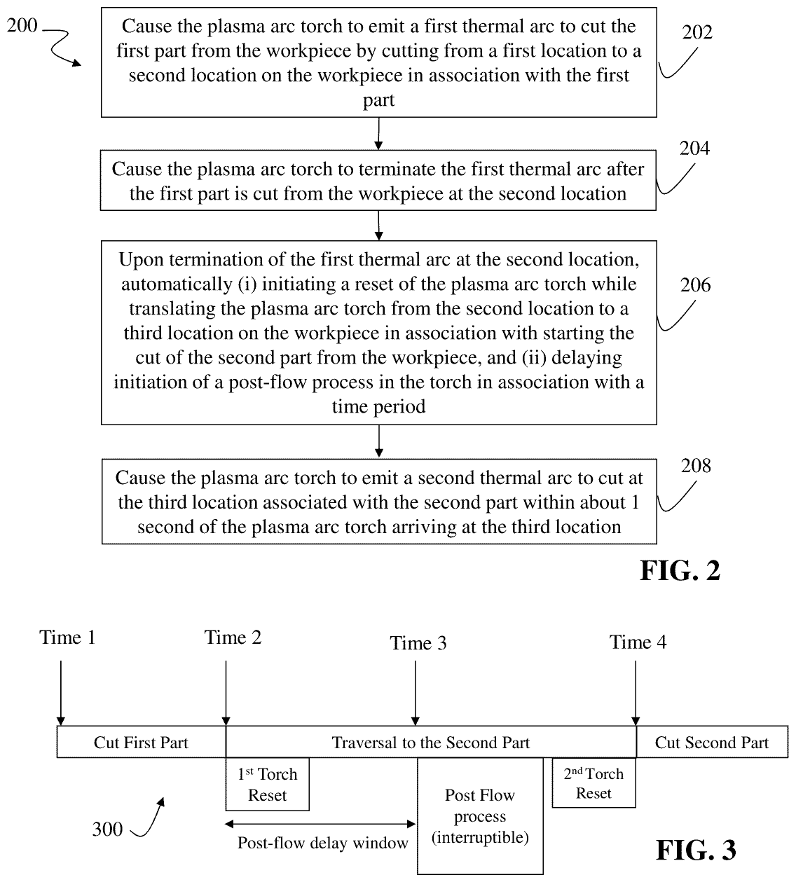

FIG. 2 shows an exemplary computerized process 200 utilizing the plasma arc processing system 100 of FIG. 1 for determining and implementing a sequence of torch actions to minimize cut-to-cut time between parts on the workpiece 106, according to some embodiments of the present invention. The process starts at step 202 with the arc initiation module 118 actuating the contact-start plasma arc torch 102 (e.g., issuing a “plasma-on” command) to emit a first thermal arc (e.g., a plasma arc) to cut a first part from the workpiece 106 by cutting from a first location to a second location on the workpiece 106 in association with the first part. At step 204, after the first part is cut from the workpiece 106 at the second location, the arc initiation module 118 actuates the torch 102 to terminate the first thermal arc.

At step 206, upon detection of the termination of the first thermal arc at the second location, the transition module 124 is adapted to initiate a reset action within the torch 102 and/or at the torch lead 122, which may occur as the torch 102 is being translated by the motion control module 120 from the second location to a third location on the workpiece 106 in association with cutting a second part from the workpiece 106 at the third location. The first and second parts are distinct and distant from each other on the workpiece 106. The reset action can comprise the transition module 124 causing gas bleed down of the torch lead 122 during the translation of torch 102 from the second location to the third location so as to depressurize gas build-up in the torch lead 122. In some embodiments, the reset action further involves the transition module 124 causing a reset of an electrode (not shown) within the plasma arc torch 102 by urging the electrode into physical contact with a nozzle (not shown) within the plasma arc torch 102.

In general, the transition module 124 is configured to initiate the reset action under the following conditions: (i) after the termination of the first thermal arc associated with cutting the first part, (ii) during translation of the torch 102 from the second location to the third location, and (iii) prior to the arc initiation module 118 actuating the torch 104 to emit a second thermal arc to start cutting at the third location in relation to the second part. In some embodiments, the transition module 124 is adapted to initiate the reset of the plasma arc torch within about 1 second after the termination of the first thermal arc (i.e., within about 1 second after the first part is cut from the workpiece 106). Performing the torch reset almost immediately after the first cut allows the bleed down to take place in parallel with the torch motion to the next part, thereby effectively saving the separate time required to perform the reset for each cut. For example, about 0.5 seconds may be saved per cut, which is the typical torch reset time needed to bleed down the pressure in the torch lead 122, and this time may be longer for longer torch leads. Therefore, a large time saving can be realized if there are many parts to be cut from the workpiece 106.

In addition, at step 206, the transition module 124 is adapted to delay initiating a post-flow process within the plasma arc torch 102 for a time period after the termination of the first thermal arc in connection with cutting the first part, such as delaying the post-flow process to at least after the reset action. This is different from a traditional cut-to-cut sequence for processing a workpiece, which requires initiation of the post-flow process almost immediately (e.g., about within 1 second) upon the termination of the first thermal arc for cutting the first part as the torch 102 translates to the start location of the next part over the workpiece 106. In some embodiments, the time period for delaying initiation of the post-flow process is measured from completion of the torch reset. Such a post-flow process can comprise flowing a cooling gas through one or more consumables of the plasma arc torch 102 to cool the torch 102 for a period of time, e.g., about 20 seconds.

The reset action and the post-flow process do not occur simultaneously or overlap while the torch 102 is being translated between cutting the first part and the second part from the workpiece 106. In some embodiments, the time period associated with delaying the post-flow process in the torch 102 from the termination of the first arc is determined based on at least one of a length of the torch lead 122, the type of at least one consumable or cartridge connected to the plasma arc torch 102, or an operator set value (e.g., about 3 seconds after the termination of the first thermal arc for cutting the first part). In some embodiments, the time period associated with delaying the post-flow process in the torch 102 after the termination of the first thermal arc is between about 0.00001 seconds to about 120 seconds, such as between about 2 seconds and about 20 seconds from the termination of the first thermal arc. As an example, the longer the torch lead 122 the more volume of gas there is in the line that would be affected by a post-flow operation (e.g., more gas in the torch lead 122 that needs to be bled off generally requires a supply of more cooling gas); and this consideration may affect calculation of the post-flow delay period. As another example, the shape and cavities within different sets of consumables contain and retain differing volumes of gas, which necessitates different post-flow delay periods. As yet another example, hy-access and flushcut style consumables require more cooling/gas flow than traditional consumables because of their more stressed environments and thermal loads; thus hy-access and flushcut style consumables may require a different post-flow delay period than that for a traditional consumable.

Given this post-flow delay time period, the transition module 124 can determine if or when to initiate the post-flow process after cutting the first part and before cutting the second part (starting at the third location on the workpiece 106). For example, if the torch 102 arrives at the third location before the delay time period expires, the transition module 124 is adapted to not implement any post-flow process between the second and third locations, in which case only the reset action is initiated within this duration. In addition, in the case of the torch 102 arriving at the third location before expiration of the post-delay time period and if the arc initiation module 118 issues a “plasma on” command within the same time period, the torch 102 is adapted to cut at the third location without the transition module 124 triggering a second reset of the torch 102. This is because the two cuts are so close to one another in time that no post-flow process or more than one torch cooling/reset is needed, and the two cuts can be essentially viewed as one from a thermal management standpoint. However, if the delay time period expires while the torch is still enroute from the second location to the third location, the transition module 124 is adapted to trigger the post-flow process, in which case both the reset action and the post-flow process are initiated between the first and second cuts. In some embodiments, if the plasma arc torch 102 arrives at the third location while the post-flow process is in progress, the transition module 124 is adapted to interrupt the post-flow process and allow the arc initiation module 118 to emit a second thermal arc to cut the second part at the third location without much delay (e.g., within about 1 second of arrival at the third location). In this case, the transition module 124 can also trigger a second torch reset action prior to cutting at the third location. Therefore, the post-flow process is an interruptible action. In some embodiments, if the plasma arc torch 102 arrives at the third location after the first torch reset and after the conclusion of the post-flow process, the transition module 124 is also adapted to initiate a second torch reset action prior to the arc initiation module 118 issues a “plasma on” command to initiate cutting at the third location. In some embodiments the transition module can determine and manipulate a dynamic reset and/or a dynamic post flow delay for each transition between parts, tailoring and adjusting a length of post flow delay and/or torch reset to the process and motion time to reduce torch idle time during processing/traversing the nest and processing the parts while improving consumables life.

Referring back to FIG. 2, after the torch 102 arrives at the third location on the workpiece 106 in relation to cutting the second part from the workpiece, the arc initiation module 118 is configured to cause the plasma arc torch 102 to emit a second thermal arc (e.g., plasma arc) to cut at the third location associated with the second part, such as within about 1 second of the plasma arc torch 102 arriving at the third location (step 208). As described above, if the post-flow process is still ongoing upon the torch's arrival at the third location, the transition module 124 is adapted to interrupt the post-flow process without delaying torch cutting at the third location. In some embodiments, the motion control module 120 is configured to translate the plasma arc torch 102 to a fourth location while translating between the second and third locations to enable purging of the plasma arc torch 102 at the fourth location. In general, the purging process is similar to a post-flow flow, whereby a large amount of gas is flown through the torch 102 to cool components of the torch 102 and clear passages within the torch 102. The motion control module 120 can direct the gantry 112 (or a robotic arm, etc.) to move the torch 102 to the fourth location away from the workpiece 108 or desired parts so as not to affect them during purging.

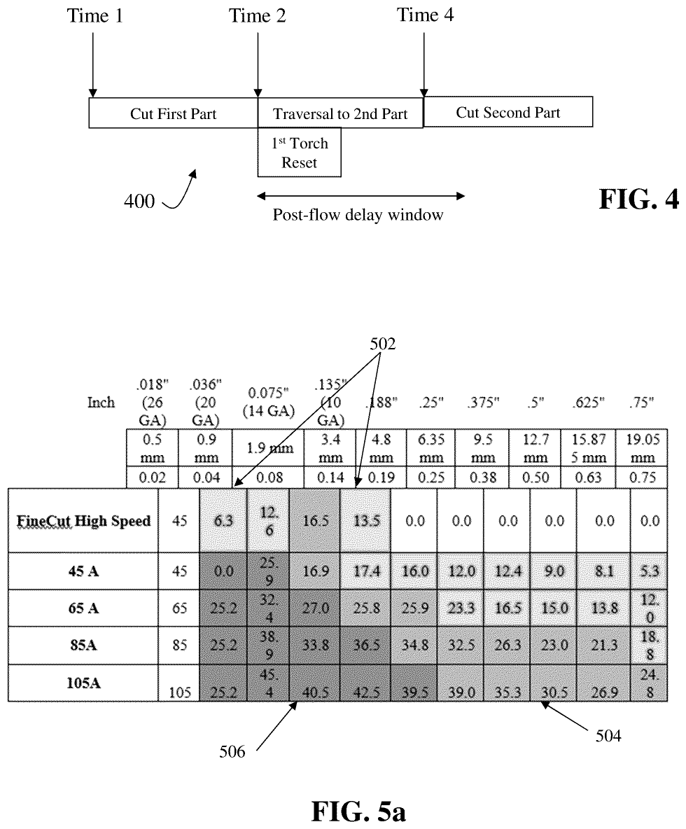

FIG. 3 shows an exemplary sequence 300 for cutting between a first part and a second part on a workpiece utilizing the plasma arc processing system 100 of FIG. 1 that employs the cut-to-cut transition process 200 of FIG. 2, according to some embodiments of the invention. At Time 1, the arc initiation module 118 issues a “plasma-on” command that causes the plasma arc torch 102 to emit a thermal arc for cutting the first part at a first location. Between Time 1 and Time 2, the torch 102 applies the thermal arc to the workpiece 106 from the first location to a second location to cut the first part from the workpiece 106. At Time 2, which is the conclusion of the cut of the first part, the arc initiation module 118 is configured to issue a “plasma-off” command to turn off the thermal arc at the second location. Substantially simultaneously with (e.g., within about 0.0001 seconds and 5 seconds, such as about 0.01 seconds and about 2 seconds, etc.) or immediately after the termination of the thermal arc, the transition module 124 is configured to initiate a torch reset that can last for about 0.5 secs (or longer depending on the length of the torch lead 122). In addition, at Time 2 the motion control module 118 is adapted to start translating the torch 102 to the second part at a third location of the workpiece 106 in preparation for cutting the second part from the workpiece 106. The torch 102 is adapted to arrive at the third location at Time 4. Therefore, during the torch translation between Time 2 and Time 4, the torch 102 is reset. Within the same duration, the post-flow process is delayed for about 3 seconds from the termination of the thermal arc at Time 2. This 3-second delay is a preset value provided by an operator. In alterative embodiments, the time delay can be calculated based on one or more factors as described above. In this example, because the torch 102 has not arrived at the third location after the 3-second delay window (i.e., the expiration of the delay window is within Time 2 and Time 4), the transition module 124 is configured to initiate the post flow process at Time 3 (between Time 2 and Time 4), which may last about 20 seconds. If the arc-initiation module 118 issues the “plasma on” command for cutting the second part while the post-flow process is in progress (not illustrated), the post flow is interrupted and cutting commences at Time 4. In addition, the transition module 124 is configured to trigger another torch reset after the post flow process (or after the post flow is interrupted) prior to cutting at Time 4. Alternatively, FIG. 4 shows an exemplary sequence 400 for cutting between a first part and a second part on a workpiece if the arc initiation module 118 of the plasma arc processing system 100 of FIG. 1 issues the “plasma on” command for cutting the second part during the post-flow delay period, according to some embodiments of the present invention. This scenario means that the torch 102 arrived at the third location prior to the expiration of the 3-second delay window. In this case, a second thermal arc is generated to commence cutting of the second part at Time 4 without triggering the post-flow process between Time 2 and Time 4 and without triggering a second torch reset between Time 2 and Time 4 in contrast to the sequence 300 of FIG. 3.

In some embodiments, the cut-to-cut transition process 200 of FIG. 2, including the cut-to-cut torch reset and the post-flow delay, is only implemented when the contact-start plasma arc torch 102 is a mechanized torch and/or has mechanized consumables (e.g., a mechanized cartridge). This process is not required if the torch 102 is of a different type, e.g., a handheld torch. For example, the power supply 116 and/or the processor 116 can implement a decision module (not shown) configured to automatically detect the type of the torch 102 (e.g., mechanized versus handheld) and implement the appropriate cut-to-cut transition process accordingly. In the case where the torch 102 is not a mechanized torch or does not have a mechanized consumable (e.g., mechanized cartridge), the transition module 124 is adapted to implement a normal transition process 200, according to which the post-flow process is implemented without delay, such as almost immediately (e.g., within about 1 second) after cutting the first part (i.e., termination of the first thermal arc) as the torch 102 transitions to the location of the second part to be cut, and a torch reset is only conducted when the torch 102 is positioned over the second/next part and the plasma-on command is received. In some embodiments, a user can, via a user interface of the power supply 116 and/or the processor 104 or via another protocol, set a serial command to enter and exit the cut-to-cut transition process 200 and/or the normal cut-to-cut transition process.

As described above, performing a torch reset almost immediately after cutting one part and before the torch reaches the next part allows the bleed down to take place in parallel with the torch motion to the next part, thereby effectively saving the separate time required to perform the reset for each cut. Thus, a large time savings can be realized if there are many parts to be cut from a workpiece. As an example, given a cut sequence of 168 parts from a single workpiece, a typical process takes about 9 minutes and 15 seconds to complete. In contrast, by employing the cut-to-cut process 200 of FIG. 2, including implementing an almost immediate torch reset and a 3-second delay in the post-flow process between cuts, the same cut sequence takes about 8 minutes and 8 seconds to complete. The time savings is about 67 seconds, or about 0.4 seconds per part.

In another aspect, the power supply 116 and/or the processor 104 implements a nesting program embedded in a hardware device (e.g., a firmware) that utilizes/incorporates modules 118, 120 and/or 124 to determine desired parameters and/or locations for processing the workpiece. For example, the nesting program can use the transition module 124 described above to schedule torch resets and/or post-flow processes between cuts to reduce torch downtime (i.e., when the plasma arc is turned off), thereby generating faster overall cut time for the parts. In some embodiments, the nesting program includes considerations for plasma processing, torch operations, and pre and post flow requirements and settings. In some embodiments, the nesting program includes instructions that position parts to be cut from a workpiece to allow for proper purges of the torch 102 in between cuts by, for example, avoiding situations where parts and/or the start cut points on parts are positioned closer to one another than the time it takes to purge the torch in between cuts, which can induce wait/idle time between cuts. In an exemplary implementation of a nesting program, if the end point of a first cut and the start point of a second cut are right next to each other, as is done frequently to reduce motion, the second part can be rotated such that the start point is further away from the end point of the first cut so that the torch can complete the reset and immediately start cutting upon arrival at the start point of the second part. Even though the resulting improvement and/or optimization in the nesting program may produce extra table motion and/or slightly less efficient use of the workpiece, it is adapted to lead to significantly less downtime on the torch 102 and thus faster overall cut time of the parts. Incorporation of process 200 in the nesting program offers advantages over traditional nesting programs that have a sequential order of cuts around parts that are clustered near each other interspersed with a few large arc-off movements to traverse to different regions of the workpiece. This is done because traditionally the torch moves much faster in an arc off situation, which is no longer the case when process 200 is implemented in a nesting program, as it significantly reduces arc-off time of the torch.

In some embodiments, in addition to minimizing time between cuts of parts from a workpiece, the nesting program can also enable high-speed cutting of the parts. To accomplish this, the nesting program can select cut parameters based in part on at least one of the thickness of the workpiece 106, the desired cut quality, and/or a balance between cut speed and selection of a process with a Speed Thickness value of greater than about 35 inches²/min, where this value can be calculated using the following equation:

Speed*Thickness(/min)=Speed Thickness Value, (Equation 1)

with “Speed” defined as the cut speed (e.g., inches per minute) and “Thickness” defined as the workpiece thickness. For example, the nesting program can select parameters to achieve a Speed Thickness value of greater than about 37 in², greater than about 40 in², greater than about 45 in², or greater than about 55 in². With respect to the example provided above with reference to FIG. 3, given the thickness of the workpiece 106, the nesting program can set the speed for cutting the first part between Time 1 and Time 2 and/or the speed for cutting the second part starting at Time 4 such that a predefined Speed Thickness value (e.g., greater than about 35 inches²/min) is satisfied.

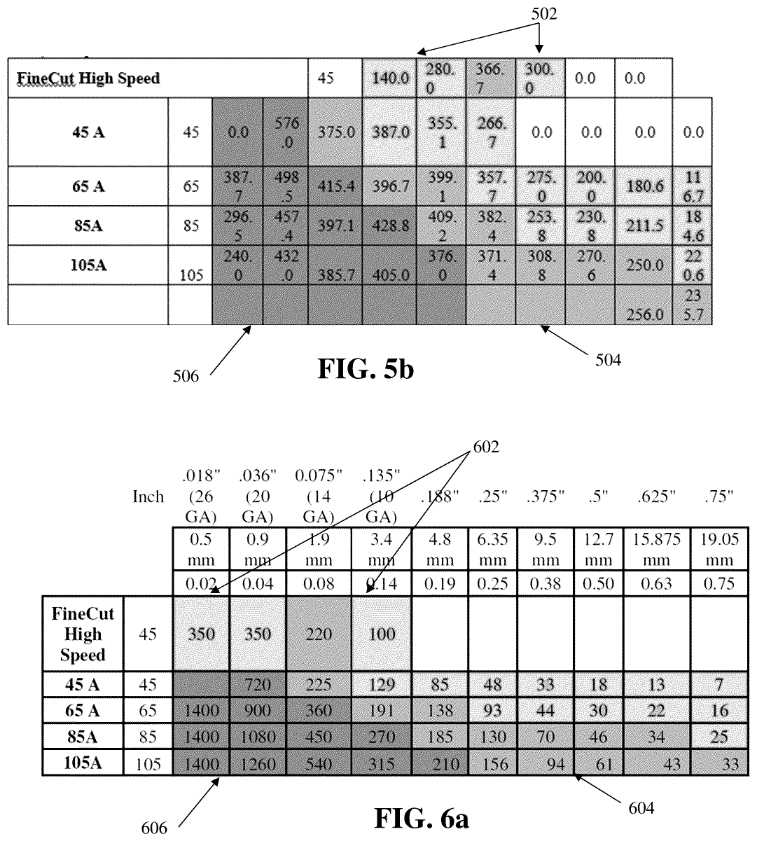

FIGS. 5a and 5b show exemplary tables of Speed Thickness values with raw calculations and a time value increase/normalization for better visibility, respectively, according to some embodiments of the present invention. Specifically, the values shown in Table 5a are the cut speed (inches per minute) multiplied by the workpiece thickness (e.g., cut speed*thickness) in accordance with embodiments of the invention, and in Table 5b are the cut speed for the workpiece thickness multiplied by 1000 (for normalization) then divided by the cut amperage. In both tables, the zone 502 and the zone 504 represent some of the fastest commercially available cut speeds achievable for a plasma arc torch in today's market when cutting gage metal workpieces of various thicknesses. These are traditional values which currently exist. The zone 506 represents the cut speeds achievable by a plasma arc torch using embodiments of the invention including at least process sequencing, transition and traversal planning, post flow delay, dynamic post flow delay, nest planning, and/or the speed-thickness calculation described above (with reference to Equation 1) on gage metal workpieces of the same thicknesses.

In some embodiments, to optimize speed of cuts through a workpiece, the nesting program can not only select cut parameters based on a desired Speed Thickness value as described above, but also based in part on a Speed-to-Amp ratio, where this ratio can be calculated using the following equation:

Speed/Amp(inch/(Amp*min))=Speed/Amp Ratio, (Equation 2)

with “Speed” defined as the cut speed (e.g., inches per minute) and “Amp” defined as the selected and/or available cut amperage (e.g., A). For example, the nesting program can select parameters to achieve a Speed-to-Amp ratio of greater than about 5 inches/min*A, such as greater than about 7 inches/min*A, greater than about 10 inches/min*A, or greater than about 15 inches/min*A. With respect to the example provided above with reference to FIG. 3, given the electrical current (i.e., cut amperage) supplied to the plasma arc torch 102, the nesting program can set the speed for cutting the first part between Time 1 and Time 2 and/or the speed for cutting the second part starting at Time 4 such that a predefined Speed-to-Amp ratio (e.g., greater than about 5 inches/min*A) is satisfied.

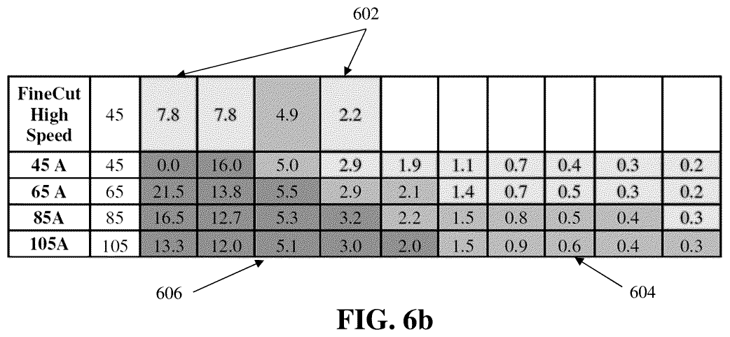

FIGS. 6a and 6b show exemplary tables of Speed-to-Amp ratios with raw calculations and time value increase/normalization for better visibility, respectively, according to some embodiments of the present invention. Specifically, in Table 6a, cut speeds for given plasma arc cutting amperages are shown in inches per minute for given workpiece thicknesses in accordance with embodiments of the invention. In Table 6b processing values are shown as the cut speed divided by the processing amperage for given workpiece thicknesses in accordance with embodiments of the invention. In both tables, the zone 602 and the zone 604 represent some of the fastest commercially available cut speeds achievable for a plasma arc torch in today's market when cutting gage metal workpieces of various thicknesses. These are traditional values which currently exist. The zone 606 represents the cut speeds achievable by a plasma arc torch using embodiments of the invention including at least process sequencing, transition and traversal planning, post flow delay, dynamic post flow delay, nest planning, and/or the speed-amp calculation described above (with reference to Equation 2) on gage metal workpieces of the same thicknesses.

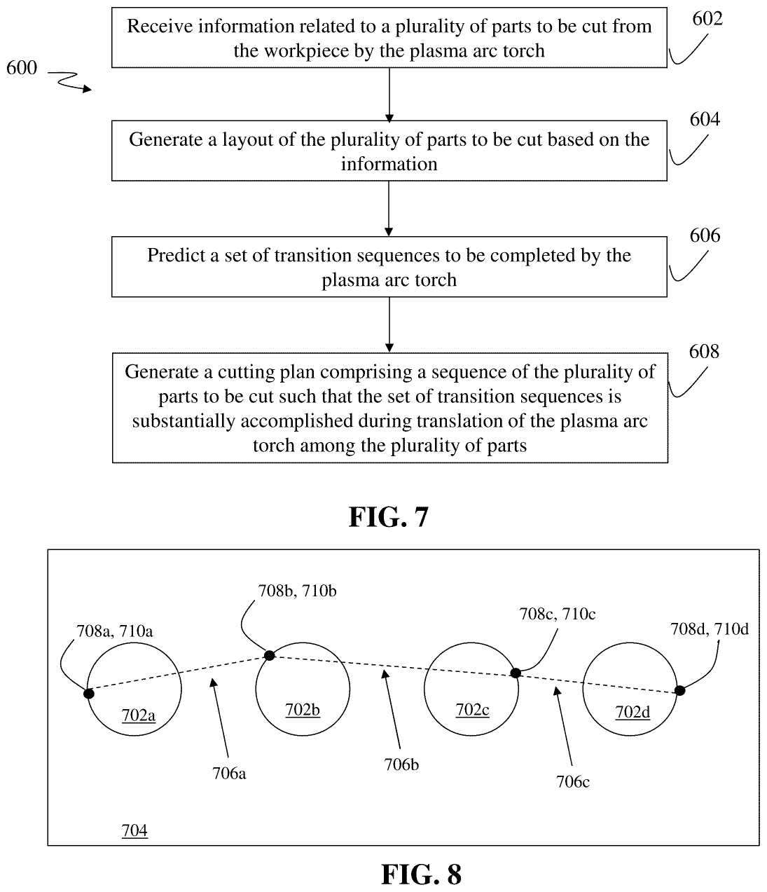

FIG. 7 shows an exemplary process 600 implemented by a nesting program of the plasma arc processing system 100 of FIG. 1 to determine a cut sequence of parts relative to a workpiece, according to some embodiments of the present invention. The process 600 starts with the nesting program of the plasma arc system 100 receiving information related to a set of parts to be cut from the workpiece 106 by the plasma arc torch 102 (step 602). Such information can include descriptions of the workpiece and the parts to be cut from the workpiece (e.g., cut eight circles with 4-inch diameters from a four-foot-by-2-foot piece of ⅛″ aluminum, or cut the outline of 7 hummingbirds as shown in the input CAD file, etc.) Based on the information received, the nesting program is adapted to generate a layout of the parts to be cut from the workpiece 106 (step 604). This layout can be generated using an existing program that accounts for proper/efficient spacing between parts to achieve good use of material, but without considering any system performance and/or speed optimizations.

The nesting program can predict a transition sequence to be completed by the plasma arc torch 102 between two cuts when transitioning/enroute from an initial part to the next part (step 606). Each transition sequence is implemented by the torch 102 in the absence of a thermal arc being generated by the torch 102. Each transition sequence can be substantially the same as the transition process described above with reference to FIG. 2. For example, during each transition sequence, (i) a reset of the plasma arc torch is implemented (e.g., almost immediately) upon termination of a thermal arc associated with cutting the initial part and (ii) a post-flow process in the torch is delayed. In some embodiments, the layout information from Step 604 is not needed for the transition sequence calculation. Alternatively, the layout information is incorporated in the transition calculation. For instance, with the layout known and transition times determined, the post-flow delays can be tailored or enabled between different parts. As an example, if there is a longer transition between two parts, the post-flow delay can be increased for that transition from, for example, 3 seconds to 7 seconds. As another example, if the only way to cut all the desired parts from a workpiece requires one very long transition in the middle between two parts and other transitions are relatively short in comparison, the post-flow delay can be eliminated for all other transitions except for that long transition.

The nesting program is further configured to generate a cutting plan that involves generating a sequence/order of the parts to be cut such that the set of transition sequences from step 606 can be substantially realized (step 608). For example, 95% or 100% of cut-to-cut transition sequences (e.g., reset, post-flow delays, etc.) are accomplished while the torch 102 is in motion during a transition between two parts to reduce torch idle time. In addition to accounting for the transition sequences between cuts when determining the sequence of the parts to be cut, the nesting program can also consider one or more additional factors/constraints, including a thickness of the workpiece 106, a desired cut quality, an available cut speed for operating the plasma arc torch 102, or an available current setting in amperage for operating the plasma arc torch 102. For example, given the thickness of the workpiece 106, the speed for cutting the parts can be constrained by a predefined speed-thickness value described above with reference to Equation 1. As another example, given an available current setting in amperage for operating the plasma arc torch 102, the speed for cutting the parts can also be constrained a predefined Speed-to-Amp ratio described above with reference to Equation 2. In turn, the resulting cut speed can be used by the nesting program to determine the sequence of the parts to be cut. In general, the nesting program generates the cutting plan with the goal of minimizing the total duration of the plasma arc torch 102 operating without a thermal arc (e.g., cut-to-cut translation time) and maximizing the total duration of the plasma arc torch 102 operating with a thermal arc (e.g., parts cutting time) by accounting for at least one of the cut-to-cut transition process of FIG. 2, the Speed Thickness values of Equation 1 or the Speed-to-Amp ratios of Equation 2.

FIG. 8 shows an exemplary nest, i.e., a cut sequence of parts, automatically generated by a nesting program using the process 600 of FIG. 7, according to some embodiments of the present invention. As shown, the nest determines a sequence of cuts of four parts 702a-d from a common workpiece 704, from Part 1 702a to Part 2 702b to Part 3 702c to Part 4 702d. Each part has a cutting start point 708a-d and an end point 710a-d that are chosen by the nesting program to substantially realize the transition sequence (e.g., accommodate reset and post-flow delay) during the transition from that part and the next part. For example, the end point of one part and the start point of the next part can be chosen such that the distance of transition between these two points can accommodate the transition sequence described above with reference to FIG. 2. For example, in FIG. 8, the path and/or distance between end point 710a and start point 708b is not the shortest nor most direct path as is conventionally chosen in nest design, rather time delay is factored into nest design and selection to reduce delays and non-processing (e.g., cutting or torch reset) portions of the nest routine. The transition between end point 710a and start point 708b is sufficiently long enough for the torch to complete a reset between processing Part 1 and Part 2 while it is traversing the transition and requires no idle time/torch motion to complete the torch reset. For the embodiment of FIG. 8, there are a total of three transitions 706a-c with transition 706a occurring between parts 702a and b (points 710a and 708b), transition 706b occurring between parts 702b and c (points 710b and 708c), and transition 706c occurring between parts 702c and d (points 710c and 708d). In addition, each cut of the parts can be designed to account for the additional factors/constraints described above, such as the realization of a predefined speed-thickness value and/or a predefined Speed-to-Amp ratio. In an alternative embodiment of the exemplary nest of FIG. 8, cut order can be Part 1 702a to Part 3 702c to Part 2 702b to Part 4 702d to substantially realize the transition sequence and/or the additional speed factors/constraints described above.

It is understood that various aspects and embodiments of the invention can be combined in various ways. Based on the teachings of this specification, a person of ordinary skill in the art can readily determine how to combine these various embodiments. Modifications may also occur to those skilled in the art upon reading the specification.

What is claimed is:

1. A material processing system comprising:
a contact-start plasma arc torch connected to a power supply via a torch lead; and
a computing device in electrical communication with the plasma arc torch, the computing device comprising:
an arc initiation module configured to (i) cause the contact-start plasma arc torch to emit a first thermal arc to cut a first part from a workpiece by cutting from a first location to a second location on the workpiece in association with the first part, and (ii) terminate the first thermal arc at the second location after the first part is cut from the workpiece; and
a transition module configured to, upon detection of the termination of the first thermal arc at the second location, automatically (i) initiate a reset of the plasma arc torch when the plasma arc torch is translated from the second location to a third location on the workpiece in association with cutting a second part from the workpiece, and (ii) delay initiation of a post-flow process in the torch in association with a time period, wherein initiate the reset of the plasma arc torch comprises cause bleed down of the torch lead during the torch translation to depressurize gas build-up in the torch lead,
wherein the arc initiation module is further configured to cause the plasma arc torch to emit a second thermal arc to cut at the third location associated with the second part within about 1 second of the plasma arc torch arrival at the third location.

2. The material processing system of claim 1, wherein the post-flow process in the torch comprises flowing a cooling gas through one or more consumables of the plasma arc torch to cool the plasma arc torch.

3. The material processing system of claim 1, wherein the transition module is configured to initiate the reset of the plasma arc torch within about 1 second of the termination of the first thermal arc.

4. The material processing system of claim 1, wherein the transition module is configured to initiate the reset of the plasma arc torch prior to the arc initiation module causing the plasma arc torch to emit the second thermal arc.

5. The material processing system of claim 1, wherein initiate the reset of the plasma arc torch by the transition module further comprises initiate a reset of an electrode within the plasma arc torch by urging the electrode into physical contact with a nozzle within the plasma arc torch.

6. The material processing system of claim 1, wherein the time period associated with delaying the post-flow process in the torch is determined based on at least one of a length of the torch lead, a type of at least one consumable or cartridge of the plasma arc torch, or an operator set value.

7. The material processing system of claim 1, wherein the time period associated with delaying the post-flow process in the torch is between about 2 seconds and about 20 seconds from the termination of the first thermal arc.

8. The material processing system of claim 1, wherein delaying the initiation of the post-flow process comprises the transition module initiating the post-flow process after the time period, if the plasma arc torch does not arrive at the third location of the second part within the time period.

9. The material processing system of claim 1, wherein delaying the initiation of the post-flow process comprises the transition module canceling the post-flow process in the plasma arc torch between the second location and the third location, if the plasma arc torch arrives at the third location within the time period.

10. The material processing system of claim 1, wherein the transition module is further configured to interrupt the post-flow process of the plasma arc torch if the plasma arc torch arrives at the third location while the post-flow process is in progress to enable the arc initiation module to initiate the second thermal arc to cut at the third location.

11. The material processing system of claim 1, wherein the computing device further comprises a decision component configured to determine a type of the plasma arc torch.

12. The material processing system of claim 11, wherein the transition module is configured to initiate the reset of the plasma arc torch and the delay of the post-flow process after the termination of the first thermal arc if the type of the plasma arc torch is a mechanized plasma arc torch.

13. The material processing system of claim 11, wherein the transition module is configured to initiate the post-flow process without delay after the termination of the first thermal arc if the type of the plasma arc torch is a handheld plasma arc torch.

14. The material processing system of claim 1, wherein the plasma arc torch cuts from the first location to the second location of the first part on the workpiece at a speed-thickness value of greater than about 35 inches²/min, wherein the speed-thickness value is defined as a speed of the plasma arc torch multiplied by a thickness of the workpiece.

15. The material processing system of claim 1, wherein the plasma arc torch cuts the first part from the first location to the second location on the workpiece at a speed-to-amp ratio of greater than about 5 inches/min*A, wherein the speed-to-amp ratio is defined as a speed of the plasma arc torch divided by an amount of electrical current supplied to the plasma arc torch.

16. The material processing system of claim 1, further comprising a motion control module configured to translate the plasma arc torch from the second location to the third location on the workpiece to enable cutting of the second part from the workpiece at the third location.

17. The material processing system of claim 16, wherein the motion control module is further configured to translate the plasma arc torch to a fourth location between the second and third location to enable purging of the plasma arc torch at the fourth location.

18. The material processing system of claim 1, wherein the computing device, including the arc initiation module and the transition module, is disposed on the power supply.

19. The material processing system of claim 18, wherein at least a portion of the transition module or the arc initiation module is embedded in a firmware of the power supply.

20. The material processing system of claim 1, wherein the arc initiation module causes the plasma arc torch to emit the first thermal arc by actuating a valve in the power supply to allow a sufficient supply of a gas to flow to the plasma arc torch, thereby generating a blowback pressure within the plasma arc torch to physically separate an electrode from contacting a nozzle in the plasma arc torch.

21. The material processing system of claim 1, wherein the transition module is further configured to automatically initiate another reset of the plasma arc torch prior to causing the plasma arc torch to emit the second thermal arc.

22. A computerized method for transitioning a contact-start plasma arc torch from cutting a first part from a workpiece to cutting a second part from the workpiece, the plasma arc torch being connected to a power supply via a torch lead, the method comprising:
causing the plasma arc torch to emit a first thermal arc to cut the first part from the workpiece by cutting from a first location to a second location on the workpiece in association with the first part;
causing the plasma arc torch to terminate the first thermal arc after the first part is cut from the workpiece at the second location;
upon termination of the first thermal arc at the second location, automatically (i) initiating a reset of the plasma arc torch while translating the plasma arc torch from the second location to a third location on the workpiece in association with starting the cut of the second part from the workpiece, and (ii) delaying initiation of a post-flow process in the torch in association with a time period, wherein initiating the reset of the plasma arc torch comprises causing bleed down of the torch lead during the translating from the second location to the third location to depressurize gas build-up in the torch lead; and
causing the plasma arc torch to emit a second thermal arc to cut at the third location associated with the second part within about 1 second of the plasma arc torch arriving at the third location.

23. The method of claim 22, wherein initiating the reset of the plasma arc torch occurs within about 1 second of the termination of the first thermal arc.

24. The method of claim 22, wherein initiating a reset of the plasma arc torch further comprises initiating a reset of an electrode within the plasma arc torch by urging the electrode into physical contact with a nozzle within the plasma arc torch.

25. The method of claim 22, wherein the time period associated with delaying initiation of the post-flow process in the torch is between about 2 seconds and about 20 seconds from the termination of the first thermal arc.

26. The method of claim 22, wherein the time period associated with delaying the post-flow process in the torch is determined based on at least one of a length of the torch lead, a type of at least one consumable or cartridge of the plasma arc torch, or an operator set value.

27. The method of claim 22, wherein delaying initiation of the post-flow process comprises initiating the post-flow process of the plasma arc torch after the time period, if the plasma arc torch does not arrive at the third location of the second part within the time period.

28. The method of claim 22, wherein delaying initiation of the post-flow process comprises canceling initiation of the post-flow process in the plasma arc torch between the second location and the third location, if the plasma arc torch arrives at the third location within the time period.

29. The method of claim 22, further comprising interrupting the post-flow process of the plasma arc torch if the plasma arc torch arrives at the third location while the post-flow process is in progress to enable initiation of the second thermal arc to cut at the third location.

30. The method of claim 22, further comprising:
determining a type of the of the plasma arc torch; and
initiating, after termination of the first thermal arc, one of (i) the reset of the plasma arc torch and the delay of the post-flow process if the type of the plasma arc torch is a mechanized plasma arc torch, or (ii) the post-flow process without delay if the type of the plasma arc torch is a handheld plasma arc torch.

31. The method of claim 22, further comprising setting a speed of the plasma arc torch to cut from the first location to the second location such that a speed-thickness value is greater than about 35 inches²/min, wherein the speed-thickness value is defined as a speed of the plasma arc torch multiplied by a thickness of the workpiece.

32. The method of claim 22, further comprising setting a speed of the plasma arc torch to cut from the first location to the second location such that a speed-to-amp ratio is greater than about 5 inches/min*A, wherein the speed-to-amp ratio is defined as a speed of the plasma arc torch divided by an amount of electrical current supplied to the plasma arc torch.

33. The method of claim 22, further comprising:
translating the plasma arc torch to a fourth location between the second and third locations on the workpiece; and
purging the plasma arc torch at the fourth location.

34. A computerized method for selecting a part nest for processing a workpiece by a plasma arc torch, the computerized method comprising:
receiving, by a computing device, information related to a plurality of parts to be cut from the workpiece by the plasma arc torch;
generating, by the computing device, a layout of the plurality of parts to be cut based on the information;
predicting, by the computing device, a set of transition sequences to be completed by the plasma arc torch based on the layout of the plurality of parts, wherein each transition sequence is intended for implementation during translation of the plasma arc torch enroute from an initial part to a next part of the plurality of parts; and
generating, by the computing device, a cutting plan comprising a sequence of the plurality of parts to be cut such that the set of transition sequences is substantially accomplished during translation of the plasma arc torch among the plurality of parts.

35. The computerized method of claim 34, wherein each transition sequence in the set of transition sequences is implemented within the plasma arc torch during the translation from the initial part to the next part, without the plasma arc torch generating a thermal arc.

36. The computerized method of claim 34, wherein the sequence of the plurality of parts in the cutting plan is generated by further accounting for at one of a thickness of the workpiece, a desired cut quality, an available cut speed for operating the plasma arc torch, or an available current setting in amperage for operating the plasma arc torch.

37. The computerized method of claim 34, wherein during each transition sequence (i) a reset of the plasma arc torch is implemented upon termination of a thermal arc associated with cutting the initial part and (ii) a post-flow process in the torch is delayed.

38. The computerized method of claim 37, wherein the reset of the plasma arc torch comprises at least one of causing bleed down of a torch lead during the torch translation to depressurize gas build-up in the torch lead or resetting an electrode within the plasma arc torch by urging the electrode into physical contact with a nozzle within the plasma arc torch, and wherein the post-flow process comprises flowing a cooling gas through one or more consumables of the plasma arc torch to cool the plasma arc torch.

39. The computerized method of claim 37, wherein the torch reset is initiated within about 1 second of the termination of the thermal arc associated with cutting the initial part.

40. The computerized method of claim 37, wherein a time period associated with delaying the post-flow process in the torch is between about 2 seconds and about 20 seconds from the termination of the thermal arc.

41. The computerized method of claim 40, wherein delaying the post-flow process comprises initiating the post-flow process after the time period during the torch translation from the initial part to the next part, if the plasma arc torch does not arrive at the next part within the time period.

42. The computerized method of claim 40, wherein delaying the post-flow process comprises cancelling the post-flow process during the translation from the initial part to the next part, if the plasma arc torch arrives at the next part within the time period.

43. The computerized method of claim 40, wherein the post-flow process is interrupted if the plasma arc torch arrives at the next part while the post-flow process is in progress to enable initiation of another thermal arc to cut the next part.

44. The computerized method of claim 34, wherein the sequence of the parts to be cut in the cutting plan is generated to minimize a total duration of the plasma arc torch operating without a thermal arc and maximize a total duration of the plasm arc torch operating with a thermal arc.
